(19) United States
(12) Patent Application Publication
(10) Pub. No.: US 2024/0172207 A1
(43) Pub. Date: May 23, 2024

(54) METHOD AND APPARATUS FOR RESOURCE ALLOCATION WITHIN A GUARD BAND IN A WIRELESS COMMUNICATION SYSTEM

(71) Applicant: ASUS Technology Licensing Inc., Taipei City (TW)

(72) Inventor: Ko-Chiang Lin, Taipei City (TW)

(21) Appl. No.: 18/507,686

(22) Filed: Nov. 13, 2023

Related U.S. Application Data
(60) Provisional application No. 63/425,007, filed on Nov. 14, 2022.

(51) Int. Cl. H04W 72/0453; H04L 5/00; H04W 72/232

(52) U.S. Cl. CPC H04W 72/0453; H04L 5/0053; H04L 5/0094; H04W 72/232

(57) ABSTRACT

Methods, systems, and apparatuses are provided for resource allocation within a guard band in a wireless communication system comprising receiving, from a base station, a Downlink Control Information (DCI) indicating the UE to receive a Physical Downlink Shared Channel (PDSCH), wherein the DCI indicates a Resource Block Group (RBG) is allocated to the UE, and wherein at least one or more first Physical Resource Blocks (PRBs) of the RBG are within a Downlink (DL) subband and at least one or more second PRBs of the RBG are outside the DL subband, receiving PDSCH on the one or more first PRBs, and not receiving PDSCH on the one or more second PRBs.

### CROSS-REFERENCE TO RELATED APPLICATIONS

The present Application claims priority to and the benefit of U.S. Provisional Patent Application Ser. No. 63/425,007, filed Nov. 14, 2022, which is fully incorporated herein by reference.

### FIELD

This disclosure generally relates to wireless communication networks and, more particularly, to a method and apparatus for resource allocation within a guard band in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for resource allocation within a guard band in a wireless communication system to provide greater efficiency of resource allocation of duplex enhancement within a guard band.

In various embodiments of the invention, a method of a User Equipment (UE) comprises receiving, from a base station, a Downlink Control Information (DCI) indicating the UE to receive a Physical Downlink Shared Channel (PDSCH), wherein the DCI indicates a Resource Block Group (RBG) is allocated to the UE, and wherein at least one or more first Physical Resource Blocks (PRBs) of the RBG are within a Downlink (DL) subband and at least one or more second PRBs of the RBG are outside the DL subband, receiving PDSCH on the one or more first PRBs, and not receiving PDSCH on the one or more second PRBs.

In various embodiments of the invention, a method of a UE comprises receiving, from a base station, a DCI indicating the UE to receive a PDSCH, wherein the DCI indicates a precoding RBG is allocated to the UE, and wherein at least one or more first PRBs of the precoding RBG are within a DL subband and at least one or more second PRBs of the precoding RBG are outside the DL subband, not receiving PDSCH on the one or more first PRBs, and not receiving PDSCH on the one or more second PRBs.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.3.1-1: Uplink-downlink timing relation, from 3GPP TS 38.211 V15.7.0, “NR physical channels and modulation”.

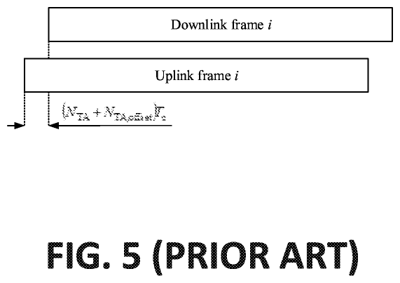

FIG. 6 is a flow diagram of a method of a UE comprising being allocated a group of PRBs for a PDSCH, receiving PDSCH on the second PRB(s), and not receiving PDSCH on the first PRB(s), in accordance with embodiments of the present invention.

FIG. 7 is a flow diagram of a method of a UE comprising receiving, from a base station, a DCI indicating the UE to receive a PDSCH, receiving PDSCH on the one or more first PRBs, and not receiving PDSCH on the one or more PRBs, in accordance with embodiments of the present invention.

FIG. 8 is a flow diagram of a method of a UE comprising receiving, from a base station, a DCI indicating the UE to receive a PDSCH, not receiving PDSCH on the one or more first PRBS, and not receiving PDSCH on the one or more second PRBs, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.211 V15.7.0, “NR physical channels and modulation”; [2] 3GPP TS 38.213 V16.6.0, “NR Physical layer procedures for control”; [3] 3GPP TS 38.321 V16.7.0, “NR MAC protocol specification”; [4] 3GPP TS 38.214 V16.10.0, “NR Physical layer procedures for data”; [5] RP-212707, “Draft SID on Evolution of NR Duplex Operation”; [6] RAN1 #110 chairman's note; and [7] RAN1 #110bis-e chairman's note. The standards and documents listed above are hereby expressly and fully incorporated herein by reference in their entirety.

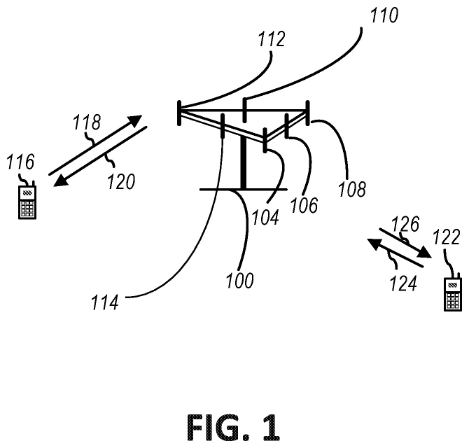

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

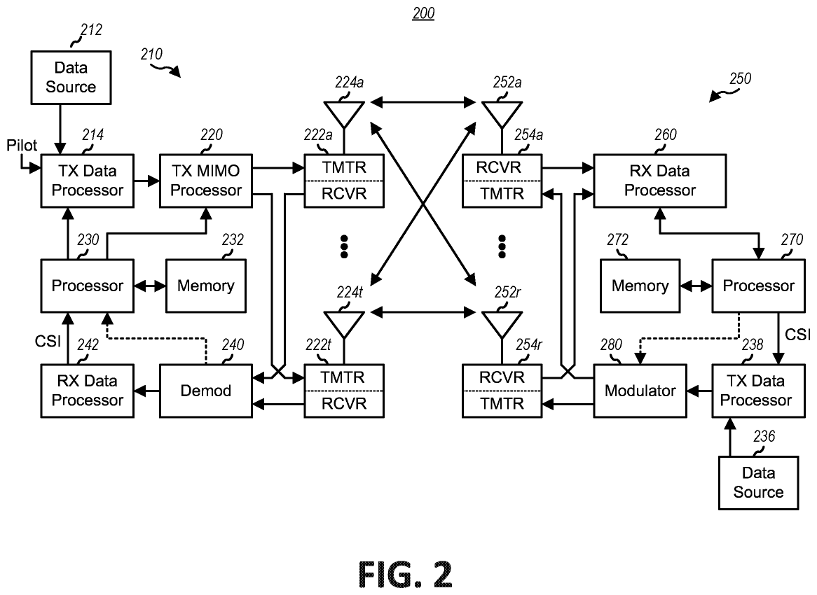

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

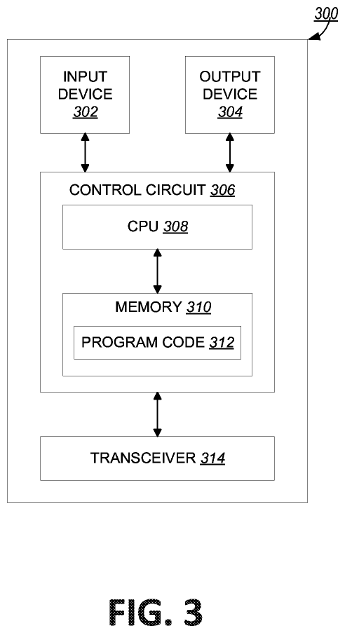

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

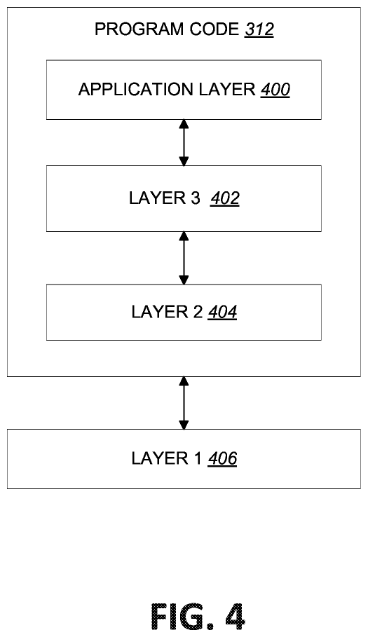

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

Frame structure used in New RAT (NR) for 5G, to accommodate various types of requirements for time and frequency resource, e.g., from ultra-low latency (˜0.5 ms) to delay-tolerant traffic for MTC, from high peak rate for eMBB to very low data rate for MTC. More details of NR frame structure, channel and numerology design are given below from [1] 3GPP TS 38.211 V15.7.0, “NR physical channels and modulation”:

Slot format information (SFI) is introduced to indicate transmission direction for a symbol(s), e.g., DL, UL or Flexible. SFI could be indicated or revealed by several signals, such as RRC configuration, DCI for SFI, scheduling DCI. Some handling would be then required if more than one direction is indicated to a symbol. More details regarding SFI is quoted below from [2] 3GPP TS 38.213 V16.6.0, “NR Physical layer procedures for control”:

Resource allocation for a data channel, e.g., PDSCH or PUSCH could be indicated via a DCI on PDCCH. A field in DCI, e.g., containing a bit map or a resource indication value (RIV) could be used to indicate resources allocated to a UE within frequency domain. Each bit within a bitmap could represent a resource block group (RBG) and a bit set to 1 would indicate PRBs within a corresponding RBG being allocated to a UE. An RIV could indicate a set of consecutive PRBs, e.g., by indicating a starting PRB and a length of allocated PRBs. In addition to allocating resources, PRB(s) could be grouped into PRG to improve accuracy of channel estimation. A base station could perform a same precoding for PRBs within a same PRG, so that when estimating the channel, the measurement across a PRG could be used to estimate channel with such prior knowledge. An optimized PRG size could be different according to different situations. The base station could determine a proper PRG size and indicate the PRG size and/or partition to the UE, e.g., via RRC configuration and/or DCI, so that the PRG information could be utilized by the UE to derive the channel. More details could be found in the following quotation from [4] 3GPP TS 38.214 V16.10.0, “NR Physical layer procedures for data”:

Duplexing enhancement has been discussed in 3GPP to enable more frequent UL so as to improve latency and UL coverage. UL transmission and DL transmission could occur on a same symbol for unpaired spectrum (e.g., TDD). More detail regarding duplexing could be found from below quotations of [5] RP-212707, “Draft SID on Evolution of NR Duplex Operation”, [6] RAN1 #110 chairman's note, and [7] RAN1 #110bis-e chairman's note:

### Issues and Solutions:

As mentioned herein, a guard band (e.g., a guard subband) could be inserted between an Uplink (UL) subband and a Downlink (DL) subband to reduce the interference between signals with the two different transmission directions. For example, a guard band could be used to increase the isolation between Transmission (Tx) and Reception (Rx), so as to reduce the interference between them. However, there could be several factors to affect frequency location and/or size of a guard band. When allocating resource for a User Equipment (UE), the granularity in frequency domain could be more than one Physical Resource Block (PRB), e.g., 4 PRBs in the case of one Resource Block Group (RBG) comprising 4 PRBs and/or one Precoding Resource Block Group (PRG) comprising 4 PRBs. It would then induce an issue that a boundary of RBG/PRG may not be aligned with a boundary of a guard band. For example, two PRBs within one RBG/PRG is within a DL subband while another two PRBs within the (same) one RBG/PRG is within a guard band. Whether and/or how to receive the corresponding PRBs and/or how to perform channel estimation under such case could be further considered.

A first concept of the present invention is to further divide/truncate a PRG and/or a RBG according to a boundary of a guard band. The PRB(s) (e.g., one or more PRBs) within a guard band is truncated from a PRG/RBG. The PRB(s) within a downlink subband or UL subband is not truncated from a PRG/RBG. The UE receives the PRB(s) from one PRG/RBG within a DL subband. The UE does not receive PRB(s) from one PRG/RBG within a guard band. The UE receives PRB(s) only within a DL subband from one PRG/RBG.

A second concept of the present invention is to allow reception/channel estimation of a whole PRG/RBG as long as at least one PRB of the PRG/RBG is within the DL subband. Reception of a PRG/RBG is not allowed if/when all PRBs of the PRG/RBG are not within a DL subband. Reception of a PRG/RBG is not allowed if/when all PRBs of the PRG/RBG are within a guard band.

A third concept of the present invention is to allow channel estimation on a guard band and not allow data channel reception within a guard band. When one PRG is spanning/across the DL subband and the guard band, a Demodulation Reference Signals (DMRS) could be transmitted within a guard band. The UE could perform channel estimation based on the whole PRG. The UE receives data from the PRB(s) within a DL subband. The UE does not receive data from the PRB(s) within a guard band.

A UE operates with a least one UL subband(s) and at least one DL subband. The UE operates with at least one guard band. A guard band could be between a DL subband and an UL subband. UL transmission could be allowed within an UL subband. DL transmission could be allowed within a DL subband. UL transmission could be allowed within a DL subband. UL transmission is not allowed within a DL subband. DL transmission could be allowed within an UL subband. DL transmission is not allowed within an UL subband. The UE could receive information of an UL subband, e.g., frequency location and/or size (bandwidth) of an UL subband. The UE could receive information of a DL subband, e.g., frequency location and/or size (bandwidth) of a DL subband. The UE could receive information of a guard band, e.g., frequency location and/or size (bandwidth) of a guard band. The UE could derive frequency location and/or size of a DL subband based on frequency location and/or size of an UL subband and/or frequency location and/or size (bandwidth) of a guard band. The UE could derive frequency location and/or size of a guard band based on frequency location and/or size of an UL subband and/or frequency location and/or size (bandwidth) of a DL subband.

In various embodiments of the invention, a UE is allocated a group of PRBs for a Physical Downlink Shared Channel (PDSCH), e.g., via an indication from a base station. The group of PRBs could be an RBG. The group of PRBs could be a PRG. At least one PRB(s) (e.g., first PRB(s)) within the group of PRBs is within a guard band. At least another one PRB(s) (e.g., second PRB(s)) within the group of PRBs is within a DL subband. The UE receives the PDSCH on the second PRB(s). The UE receives the PDSCH when/if the second PRB(s) is within a DL subband. The UE receives the PDSCH on the second PRB(s) due to the second PRB(s) being within a DL subband. The UE does not receive the PDSCH on the first PRB(s). The UE does not receive the PDSCH on the first PRB(s) when/if the first PRB(s) is within a guard band. The UE does not receive the PDSCH on the first PRB(s) due to the first PRB(s) being within a guard band. The UE receives the PDSCH excluding the second PRB(s). The UE performs channel estimation (e.g., for the PDSCH) (based) on the second PRB(s). The UE performs channel estimation (e.g., for the PDSCH) (based) on the second PRB(s) if/when the second PRB(s) is within a DL subband. The UE performs channel estimation (e.g., for the PDSCH) (based) on the second PRB(s) due to the second PRB(s) being within a DL subband. The UE does not perform channel estimation (e.g., for the PDSCH) (based) on the first PRB(s). The UE does not perform channel estimation (e.g., for the PDSCH) (based) on the first PRB(s) when/if the first PRB(s) is within a guard band. The UE does not perform channel estimation (e.g., for the PDSCH) (based) on the first PRB(s) due to the first PRB(s) being within a guard band. The UE performs channel estimation (e.g., for the PDSCH) excluding the second PRB(s). The UE does not perform channel estimation (e.g., for the PDSCH) based on the second PRB(s).

In various embodiments of the invention, a base station allocates a group of PRBs to a UE for a PDSCH, e.g., via an indication to the UE. The group of PRBs could be an RBG. The group of PRBs could be a PRG. At least one PRB(s) (e.g., first PRB(s)) within the group of PRBs is within a guard band. At least another one PRB(s) (e.g., second PRB(s)) within the group of PRBs is within a DL subband. The base station transmits the PDSCH on the second PRB(s). The base station transmits the PDSCH when/if the second PRB(s) is within a DL subband. The base station transmits the PDSCH on the second PRB(s) due to the second PRB(s) being within a DL subband. The base station does not transmit the PDSCH on the first PRB(s). The base station does not transmit the PDSCH on the first PRB(s) when/if the first PRB(s) is within a guard band. The base station does not transmit the PDSCH on the first PRB(s) due to the first PRB(s) being within a guard band. The base station transmits the PDSCH excluding the second PRB(s). The base station bundles (e.g., for the PDSCH) the second PRB(s). The base station bundles (e.g., for the PDSCH) on the second PRB(s) if/when the second PRB(s) is within a DL subband. The base station bundles (e.g., for the PDSCH) on the second PRB(s) due to the second PRB(s) being within a DL subband. The base station does not bundle (e.g., for the PDSCH) the first PRB(s). The base station does not bundle (e.g., for the PDSCH) the first PRB(s) when/if the first PRB(s) is within a guard band. The base station does not bundle (e.g., for the PDSCH) the first PRB(s) due to the first PRB(s) being within a guard band. The base station bundles PRBs (e.g., for the PDSCH) excluding the second PRB(s).

In various embodiments of the invention, a UE is allocated a first group of PRBs for a PDSCH, e.g., via an indication from a base station. The first group of PRBs could be an RBG. The first group of PRBs could be a PRG. At least one PRB(s) (e.g., first PRB(s)) within the group of PRBs is within a guard band. At least another one PRB(s) (e.g., second PRB(s)) within the first group of PRBs is within a DL subband. The UE receives the PDSCH on the first group of PRB(s). The UE receives the PDSCH on the first group of PRBs when/if at least one PRB (e.g., second PRB(s)) within the first group of PRBs is within a DL subband. The UE receives the PDSCH on the first group of PRB(s) due to at least one PRB being within a DL subband. The UE does not expect to be allocated a second group of PRB(s) for a PDSCH, e.g., via an indication from a base station. The UE is allocated a second group of PRB(s) for a PDSCH, e.g., via an indication from a base station. The UE does not receive PDSCH on the second group of PRB(s). The second group of PRB(s) are (all) within a guard band. The UE does not receive PDSCH on the second group of PRB(s) when/if the second group of PRB(s) are all within a guard band. The UE does not receive PDSCH on the second group of PRB(s) due to the second group of PRB(s) all being within a guard band.

In various embodiments of the invention, a base station allocates a first group of PRBs to a UE for a PDSCH, e.g., via an indication to the UE. The first group of PRBs could be an RBG. The first group of PRBs could be a PRG. At least one PRB(s) (e.g., first PRB(s)) within the group of PRBs is within a guard band. At least another one PRB(s) (e.g., second PRB(s)) within the first group of PRBs is within a DL subband. The base station transmits the PDSCH on the first group of PRB(s). The base station transmits the PDSCH on the first group of PRBs when/if at least one PRB (e.g., second PRB(s)) within the first group of PRBs is within a DL subband. The base station transmits the PDSCH on the first group of PRB(s) due to at least one PRB being within a DL subband. The base station is not allowed (or is prohibited from) to schedule a second group of PRB(s) for a PDSCH, e.g., via an indication to the UE. The base station allocates a second group of PRB(s) to the UE for a PDSCH, e.g., via an indication to the UE. The base station does not transmit PDSCH on the second group of PRB(s). The second group of PRB(s) are (all) within a guard band. The base station does not transmit PDSCH on the second group of PRB(s) when/if the second group of PRB(s) are all within a guard band. The base station does not transmit PDSCH on the second group of PRB(s) due to the second group of PRB(s) all being within a guard band.

In various embodiments of the invention, a UE is allocated a group of PRBs for a PDSCH, e.g., via an indication from a base station. The group of PRBs could be an RBG. The group of PRBs could be a PRG. At least one PRB(s) (e.g., first PRB(s)) within the group of PRBs is within a guard band. At least another one PRB(s) (e.g., second PRB(s)) within the group of PRBs is within a DL subband. The UE receives the PDSCH on the second PRB(s). The UE receives the PDSCH when/if the second PRB(s) is within a DL subband. The UE receives the PDSCH on the second PRB(s) due to the second PRB(s) being within a DL subband. The UE does not receive the PDSCH on the first PRB(s). The UE does not receive the PDSCH on the first PRB(s) when/if the first PRB(s) is within a guard band. The UE does not receive the PDSCH on the first PRB(s) due to the first PRB(s) being within a guard band. The UE receives the PDSCH excluding the second PRB(s). The UE performs channel estimation (e.g., for the PDSCH) (based) on the group of PRB(s). The UE performs channel estimation (e.g., for the PDSCH) (based) on the group of PRB(s) if/when at least one PRB within the group of PRB(s) is within a DL subband. The UE performs channel estimation (e.g., for the PDSCH) (based) on the group of PRB(s) due to at least one PRB within the group of PRB(s) being within a DL subband. The UE receives DMRS on the group of PRB(s). The UE receives DMRS on all PRBs within the group of PRB(s).

In various embodiments of the invention, a base station allocates a group of PRBs to a UE for a PDSCH, e.g., via an indication to the UE. The group of PRBs could be an RBG. The group of PRBs could be a PRG. At least one PRB(s) (e.g., first PRB(s)) within the group of PRBs is within a guard band. At least another one PRB(s) (e.g., second PRB(s)) within the group of PRBs is within a DL subband. The base station transmits the PDSCH on the second PRB(s). The base station transmits the PDSCH when/if the second PRB(s) is within a DL subband. The base station transmits the PDSCH on the second PRB(s) due to the second PRB(s) being within a DL subband. The base station does not transmit the PDSCH on the first PRB(s). The base station does not transmit the PDSCH on the first PRB(s) when/if the first PRB(s) is within a guard band. The base station does not transmit the PDSCH on the first PRB(s) due to the first PRB(s) being within a guard band. The base station transmits the PDSCH excluding the second PRB(s). The base station bundle (e.g., performs a same precoding on) (e.g., for the PDSCH) the group of PRB(s). The base station bundle (e.g., performs a same precoding on) (e.g., for the PDSCH) the group of PRB(s) if/when at least one PRB within the group of PRB(s) is within a DL subband. The base station bundle (e.g., performs a same precoding on) (e.g., for the PDSCH) the group of PRB(s) due to at least one PRB within the group of PRB(s) being within a DL subband. The base station transmits DMRS (e.g., for the PDSCH) on the group of PRB(s). The base station transmits DMRS (e.g., for the PDSCH) on all PRBs within the group of PRB(s) (e.g., including first PRB(s)).

In various embodiments of the invention, a subband could be replaced by a Channel State Information (CSI) subband, a subband for CSI, a subband for Slot Form Indicator (SFI), a subband for duplex enhancement, a subband for transmission direction, or a subband for subband SFI unless otherwise noted.

In various embodiments of the invention, transmission direction could be one or more of DL, UL, flexible, reserved, blank, or sidelink.

In various embodiments of the invention, the invention describes behavior or operation of a single serving cell unless otherwise noted.

In various embodiments of the invention, the invention describes behavior or operation of multiple serving cells unless otherwise noted.

In various embodiments of the invention, the invention describes behavior or operation of a single bandwidth part unless otherwise noted.

In various embodiments of the invention, a base station configures multiple bandwidth parts to the UE unless otherwise noted.

In various embodiments of the invention, a base station configures a single bandwidth part to the UE unless otherwise noted.

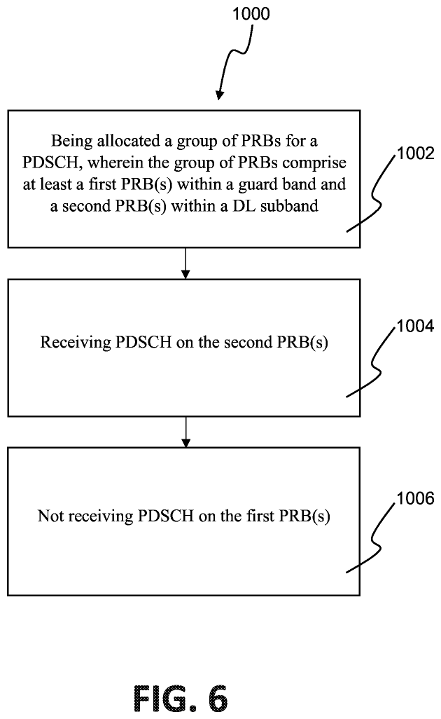

Referring to FIG. 6, with this and other concepts, systems, and methods of the present invention, a method 1000 for a UE in a wireless communication system comprises being allocated a group of PRBs for a PDSCH, wherein the group of PRBs comprise at least a first PRB(s) within a guard band and a second PRB(s) within a DL subband (step 1002), receiving PDSCH on the second PRB(s) (step 1004), and not receiving PDSCH on the first PRB(s) (step 1006).

In various embodiments of the invention, the group of PRBs could be a PRG.

In various embodiments of the invention, the group of PRBs could be an RBG.

In various embodiments of the invention, the UE receives PDSCH on the second PRB(s) if the second PRB(s) is within a DL subband.

In various embodiments of the invention, the UE receives PDSCH on the second PRB(s) due to the second PRB(s) being within a DL subband.

In various embodiments of the invention, the UE does not receive PDSCH on the first PRB(s) if the first PRB(s) is within a guard band.

In various embodiments of the invention, the UE does not receive PDSCH on the first PRB(s) due to the first PRB(s) being within a guard band.

In various embodiments of the invention, the UE performs channel estimation on the second PRB(s).

In various embodiments of the invention, the UE performs channel estimation on the second PRB(s) if the second PRB(s) is within a DL subband.

In various embodiments of the invention, the UE performs channel estimation on the second PRB(s) due to the second PRB(s) being within a DL subband.

In various embodiments of the invention, the UE does not perform channel estimation on the first PRB(s).

In various embodiments of the invention, the UE does not perform channel estimation on the first PRB(s) if the first PRB(s) is within a guard band.

In various embodiments of the invention, the UE does not perform channel estimation on the first PRB(s) due to the first PRB(s) being within a guard band.

Referring back to FIGS. 3 and 4, in one or more embodiments from the perspective of a first UE, the device 300 includes a program code 312 stored in memory 310 of the transmitter. The CPU 308 could execute program code 312 to: (i) being allocated a group of PRBs for a PDSCH, wherein the group of PRBs comprise at least a first PRB(s) within a guard band and a second PRB(s) within a DL subband; (ii) receiving PDSCH on the second PRB(s); and (iii) not receiving PDSCH on the first PRB(s). Moreover, the CPU 308 can execute the program code 312 to perform all of the described actions, steps, and methods described above, below, or otherwise herein.

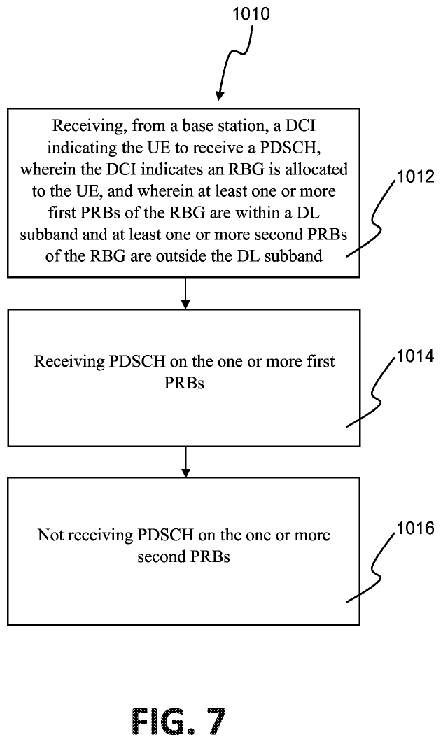

Referring to FIG. 7, with this and other concepts, systems, and methods of the present invention, a method 1010 for a UE in a wireless communication system comprises receiving, from a base station, a DCI indicating the UE to receive a PDSCH, wherein the DCI indicates an RBG is allocated to the UE, and wherein at least one or more first PRBs of the RBG are within a DL subband and at least one or more second PRBs of the RBG are outside the DL subband (step 1012), receiving PDSCH on the one or more first PRBs (step 1014), and not receiving PDSCH on the one or more second PRBs (step 1016).

In various embodiments of the invention, the PDSCH is on a SBFD symbol.

In various embodiments of the invention, the DL subband is for SBFD operation.

In various embodiments of the invention, the one or more second PRBs are within a guard band.

In various embodiments of the invention, the one or more second PRBs are within an UL subband.

In various embodiments of the invention, the UE is not expected to be allocated a second RBG, wherein all PRBs within the second RBG are outside the DL subband.

In various embodiments of the invention, the UE receives PDSCH on all PRBs of a third RBG, and wherein all PRBs within the third RBG are outside the DL subband when the third RBG is allocated to the UE.

In various embodiments of the invention, the method further comprises receiving a DMRS on the one or more second PRBs.

In various embodiments of the invention, the method further comprises performing channel estimation based on the one or more second PRBs.

In various embodiments of the invention, the RBG is a precoding RBG.

Referring back to FIGS. 3 and 4, in one or more embodiments from the perspective of a first UE, the device 300 includes a program code 312 stored in memory 310 of the transmitter. The CPU 308 could execute program code 312 to: (i) receiving, from a base station, a DCI indicating the UE to receive a PDSCH, wherein the DCI indicates an RBG is allocated to the UE, and wherein at least one or more first PRBs of the RBG are within a DL subband and at least one or more second PRBs of the RBG are outside the DL subband; (ii) receiving PDSCH on the one or more first PRBs; and (iii) not receiving PDSCH on the one or more second PRBs. Moreover, the CPU 308 can execute the program code 312 to perform all of the described actions, steps, and methods described above, below, or otherwise herein.

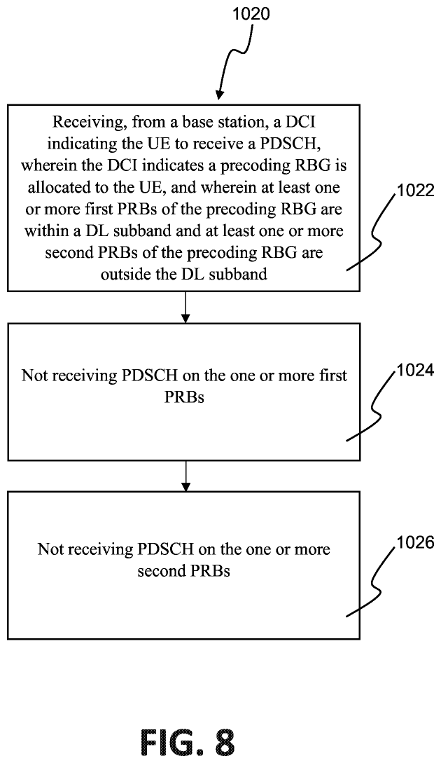

Referring to FIG. 8, with this and other concepts, systems, and methods of the present invention, a method 1020 for a UE in a wireless communication system comprises receiving, from a base station, a DCI indicating the UE to receive a PDSCH, wherein the DCI indicates a precoding RBG is allocated to the UE, and wherein at least one or more first PRBs of the precoding RBG are within a DL subband and at least one or more second PRBs of the precoding RBG are outside the DL subband (step 1022), not receiving PDSCH on the one or more first PRBs (step 1024), and not receiving PDSCH on the one or more second PRBs (step 1026).

In various embodiments of the invention, the PDSCH is on a SBFD symbol.

In various embodiments of the invention, the DL subband is for SBFD operation.

In various embodiments of the invention, the one or more second PRBs are within a guard band.

In various embodiments of the invention, the one or more second PRBs are within an Uplink UL subband.

Referring back to FIGS. 3 and 4, in one or more embodiments from the perspective of a first UE, the device 300 includes a program code 312 stored in memory 310 of the transmitter. The CPU 308 could execute program code 312 to: (i) receiving, from a base station, a DCI indicating the UE to receive a PDSCH, wherein the DCI indicates a precoding RBG is allocated to the UE, and wherein at least one or more first PRBs of the precoding RBG are within a DL subband and at least one or more second PRBs of the precoding RBG are outside the DL subband; (ii) not receiving PDSCH on the one or more first PRBs; and (iii) not receiving PDSCH on the one or more second PRBs. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
receiving, from a base station, a Downlink Control Information (DCI) indicating the UE to receive a Physical Downlink Shared Channel (PDSCH), wherein the DCI indicates a Resource Block Group (RBG) is allocated to the UE, and wherein at least one or more first Physical Resource Blocks (PRBs) of the RBG are within a Downlink (DL) subband and at least one or more second PRBs of the RBG are outside the DL subband;
receiving PDSCH on the one or more first PRBs; and
not receiving PDSCH on the one or more second PRBs.

2. The method of claim 1, wherein the PDSCH is on a Subband Full Duplex (SBFD) symbol.

3. The method of claim 1, wherein the DL subband is for SBFD operation.

4. The method of claim 1, wherein:
the one or more second PRBs are within a guard band; or
the one or more second PRBs are within an Uplink (UL) subband.

5. The method of claim 1, wherein the UE is not expected to be allocated a second RBG, wherein all PRBs within the second RBG are outside the DL subband.

6. The method of claim 1, wherein the UE receives PDSCH on all PRBs of a third RBG, and wherein all PRBs within the third RBG are outside the DL subband when the third RBG is allocated to the UE.

7. The method of claim 1, further comprising receiving a Demodulation Reference Signal (DMRS) on the one or more second PRBs.

8. The method of claim 1, further comprising performing channel estimation based on the one or more second PRBs.

9. The method of claim 1, wherein the RBG is a precoding RBG.

10. A method of a User Equipment (UE), comprising:
receiving, from a base station, a Downlink Control Information (DCI) indicating the UE to receive a Physical Downlink Shared Channel (PDSCH), wherein the DCI indicates a precoding Resource Block Group (RBG) is allocated to the UE, and wherein at least one or more first Physical Resource Blocks (PRBs) of the precoding RBG are within a Downlink (DL) subband and at least one or more second PRBs of the precoding RBG are outside the DL subband;
not receiving PDSCH on the one or more first PRBs; and
not receiving PDSCH on the one or more second PRBs.

11. The method of claim 10, wherein the PDSCH is on a Subband Full Duplex (SBFD) symbol.

12. The method of claim 10, wherein the DL subband is for SBFD operation.

13. The method of claim 10, wherein:
the one or more second PRBs are within a guard band; or
the one or more second PRBs are within an Uplink (UL) subband.

14. A User Equipment (UE), comprising:
a memory; and
a processor operatively coupled to the memory, wherein the processor is configured to execute a program code to:
receive, from a base station, a Downlink Control Information (DCI) indicating the UE to receive a Physical Downlink Shared Channel (PDSCH), wherein the DCI indicates a Resource Block Group (RBG) is allocated to the UE, and wherein at least one or more first Physical Resource Blocks (PRBs) of the RBG are within a Downlink (DL) subband and at least one or more second PRBs of the RBG are outside the DL subband;
receive PDSCH on the one or more first PRBs; and
not receive PDSCH on the one or more second PRBs.

15. The UE of claim 14, wherein the PDSCH is on a Subband Full Duplex (SBFD) symbol.

16. The UE of claim 14, wherein the DL subband is for SBFD operation.

17. The UE of claim 14, wherein:
the one or more second PRBs are within a guard band; or
the one or more second PRBs are within an Uplink (UL) subband.

18. The UE of claim 14, wherein:
the UE receives PDSCH on all PRBs of a third RBG, and wherein all PRBs within the third RBG are outside the DL subband when the third RBG is allocated to the UE; or
the UE receives a Demodulation Reference Signal (DMRS) on the one or more second PRBs.

19. The UE of claim 14, wherein:
the UE is not expected to be allocated a second RBG, wherein all PRBs within the second RBG are outside the DL subband; or
the UE performs channel estimation based on the one or more second PRBs.

20. The UE of claim 14, wherein the RBG is a precoding RBG.
